(19) United States
(12) Patent Application Publication
(10) Pub. No.: US 2004/0019773 A1
(43) Pub. Date: Jan. 29, 2004

(54) Illegal instruction processing method and processor

(75) Inventors: Nobuyuki Myoga, Kawasaki (JP); Yasunori Izumiya, Kawasaki (JP); Keiichi Sato, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/306,076

(22) Filed: Nov. 27, 2002

(30) Foreign Application Priority Data
Jul. 25, 2002 (JP) 2002-216601

(51) Int. Cl. G06F 9/00

(52) U.S. Cl. 712/244

(57) ABSTRACT

An illegal instruction processing method is adapted for a processor which executes programs, and detects execution of an illegal instruction and carries out a retry from an instruction immediately prior to the illegal instruction when the execution of the illegal instruction is detected.

### BACKGROUND OF THE INVENTION

This application claims the benefit of a Japanese Patent Application No.2002-216601 filed Jul. 25, 2002, in the Japanese Patent Office, the disclosure of which is hereby incorporated by reference.

1. Field of the Invention

The present invention generally relates to illegal instruction processing methods and processors, and more particularly to an illegal instruction processing method which processes an illegal instruction of a processor, and to a processor which employs such an illegal instruction processing method.

2. Description of the Related Art

A processor may execute an illegal instruction when a clock dropout, a crosstalk of an internal program bus, or the like occurs. The illegal instruction is detected by an illegal instruction detecting circuit which carries out a parity check, an operation code check when decoding an instruction, a check to determine whether all bits of a code match 0000h or FFFFh, for example, or like. When the illegal instruction is detected by the illegal instruction detecting circuit, a restart of the processor, a retry of a series of processes executed at the time when the error was generated, or the like is carried out by program intervention.

A Japanese Laid-Open Patent Application No.55-87251 proposes an illegal instruction processing method using two processors. According to this first proposed method, the instructions are normally executed by the main processor, but when an error is generated and detected by a parity check circuit or the like, a retry is carried out by the sub processor. At the time of the retry, register contents of the main processor are copied to the sub processor, and the instructions are executed again starting from the instruction at which the error was generated.

A Japanese Laid-Open Patent Application No.57-62446 proposes an illegal instruction processing method using a storage unit for saving. According to, this second proposed method, register contents are saved in the storage unit and the process is interrupted when an error is generated, and the generation of the error is notified to the operator. The error is detected by a parity check circuit or the like. After the operator removes the cause of the error, the interrupted process is resumed based on the saved register contents.

A Japanese Laid-Open Patent Application No.158747 proposes an illegal instruction processing method using a check sum. According to this third proposed method, a program is executed, and the legitimacy of the program is evaluated after execution by using the check sum. The check sum is compared with a true value, and if the check sum is different from the true value, the program is re-executed based on data which is saved in advance prior to execution of the program. In the case of a burst error generated by noise or the like, the possibility of remedying the error by the re-execution of the program is high. In a case where the error is generated even when the program is re-executed, the process jumps to an error processing routine and the processor is stopped.

According to the first proposed method, the hardware structure and the switching control of the processors become complex, and it is difficult to realize an inexpensive system, because two processors are used. In addition, when carrying out the retry, it is necessary to set a check point which indicates a start of the process at many parts of the program. As a result, a complex judging process becomes necessary as the program size increases.

According to the second proposed method, the interrupted process is resumed based on the saved register contents, after the operator removes the cause of the error. For this reason, it takes time to complete the process, and the system utilization efficiency is poor because process continuity cannot be maintained with respect to the process carried out immediately before the error is generated.

According to the third proposed method, the check sum and the true value are compared, and the program is re-executed based on the data which is saved in advance prior to execution of the program if the check sum is different from the true value. For this reason, the system utilization efficiency is poor because process continuity cannot be maintained with respect to the process carried out immediately before the error is generated. Furthermore, when carrying out the retry, it is necessary to set a check point which indicates a start of the process at many parts of the program. Consequently, a complex judging process becomes necessary as the program size increases.

### SUMMARY OF THE INVENTION

Accordingly, it is a general object of the present invention to provide a novel and useful illegal instruction processing method and processor, in which the problems described above are eliminated.

Another and more specific object of the present invention is to provide an illegal instruction processing method and a processor, which use a relatively simple and inexpensive structure to process illegal instructions without increasing the program size or requiring complex judging processes, and prevent deterioration of the system utilization efficiency by maintaining process continuity with respect to a process carried out immediately before an error is generated.

Still another object of the present invention is to provide an illegal instruction processing method adapted for a processor which executes programs, comprising detecting execution of an illegal instruction, and carrying out a retry from an instruction immediately prior to the illegal instruction when the execution of the illegal instruction is detected. According to the illegal instruction processing method of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

A further object of the present invention is to provide an illegal instruction processing method adapted for a processor which executes programs, comprising detecting execution of an illegal instruction, and carrying out a retry from a subroutine immediately prior to a subroutine including the illegal instruction when the execution of the illegal instruction is detected. According to the illegal instruction processing method of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

Another object of the present invention is to provide an illegal instruction processing method adapted for a processor which executes programs, comprising detecting reading of an illegal instruction, and reading an instruction again without executing the illegal instruction when the reading of the illegal instruction is detected. According to the illegal instruction processing method of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

Still another object of the present invention is to provide a processor for executing programs, comprising a detecting part detecting execution of an illegal instruction, and a retry part carrying out a retry from an instruction immediately prior to the illegal instruction when the execution of the illegal instruction is detected by the detecting part. According to the processor of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

A further object of the present invention is to provide a processor for executing programs, comprising a detecting part detecting execution of an illegal instruction, and a retry part carrying out a retry from a subroutine immediately prior to a subroutine including the illegal instruction when the execution of the illegal instruction is detected by the detecting part. According to the processor of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

Another object of the present invention is to provide a processor for executing programs, comprising a detecting part detecting reading of an illegal instruction, and a reading section reading an instruction again without executing the illegal instruction when the reading of the illegal instruction is detected by the detecting part. According to the processor of the present invention, it is possible to use a relatively simple and inexpensive structure to process illegal instructions without increasing the program size or requiring complex judging processes, and to prevent deterioration of the system utilization efficiency by maintaining process continuity with respect to a process carried out immediately before an error is generated.

Other objects and further features of the present invention will be apparent from the following detailed description when read in conjunction with the accompanying drawings.

### BRIEF DESCRIPTION OF THE DRAWINGS

FIG. 1 is a system block diagram showing the general structure of a first embodiment of a processor according to the present invention;

FIG. 2 is a flow chart for explaining the operation of the first embodiment;

FIG. 3 is a diagram for explaining the operation of the first embodiment;

FIGS. 4A through 4E are diagrams for explaining register contents of the first embodiment;

FIG. 5 is a system block diagram showing the general structure of a second embodiment of the processor according to the present invention;

FIG. 6 is a flow chart for explaining the operation of the second embodiment;

FIGS. 7A and 7B are diagrams for explaining register contents of a conventional processor;

FIGS. 8A and 8B are diagrams for explaining register contents of the second embodiment;

FIG. 9 is a system block diagram showing the general structure of a third embodiment of the processor according to the present invention;

FIG. 10 is a flow chart for explaining the operation of the third embodiment;

FIGS. 11A, 11B and 11C are diagrams for explaining the operation of the third embodiment;

FIG. 12 is a diagram for explaining the operation of the third embodiment; and

FIG. 13 is a diagram for explaining the operation of the third embodiment.

### DESCRIPTION OF THE PREFERRED EMBODIMENTS

A description will be given of various embodiments of an illegal instruction processing method according to the present invention and a processor according to the present invention, by referring to the drawings.

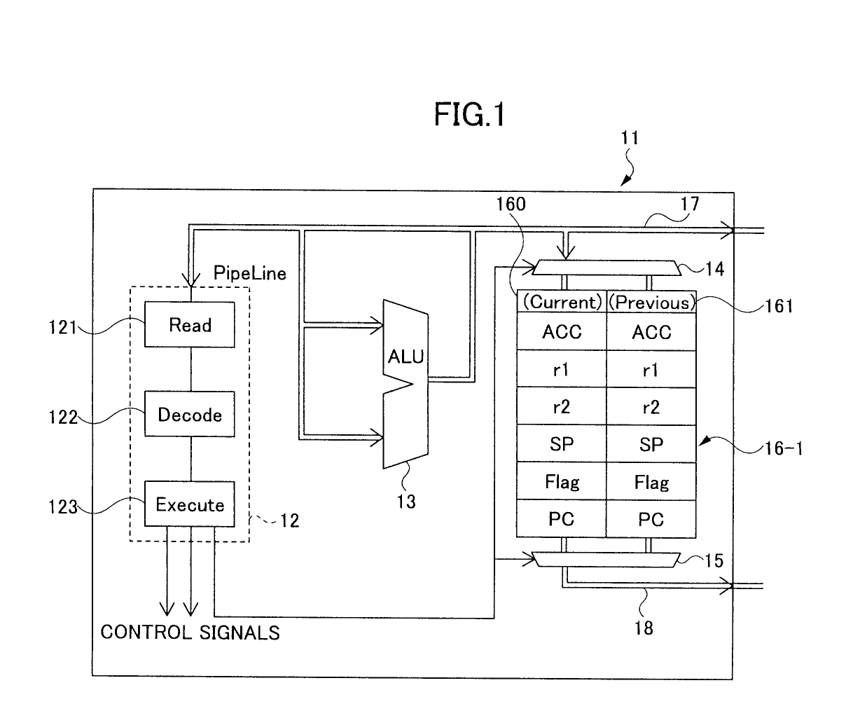

FIG. 1 is a system block diagram showing the general structure of a first embodiment of the processor according to the present invention. In this first embodiment of the processor, the present invention is applied to a central processing unit (CPU), and a first embodiment of the illegal instruction processing method is employed.

In FIG. 1, a processor 11 includes a pipeline processing section 12, an ALU 13, selectors 14 and 15, a register section 16-1, a data bus 17, and an address bus 18. The pipeline processing section 12 includes a read part (Read) 121, a decode part (Decode) 122, and an execute part (Execute) 123. The read part 121 reads and stores an instruction. The decode part 122 decodes the instruction which is read by the read part 121, and judges whether or not the instruction is supported, that is, whether the instruction is legitimate or illegal. The execute part 123 executes the instruction which is decoded by the decode part 122, and supplies control signals to various parts within the processor 11. The control signals output from the execute part 123 are also supplied to the selectors 14 and 15.

The register section 16-1 includes a register 160 for storing present data (hereinafter referred to as the present register 160), and a register 161 for storing previous data (hereinafter referred to as the previous register 161. Each of the registers 160 and 161 includes an accumulator ACC for storing a computation result of the ALU 13, general purpose registers r1 and r2, a stack pointer SP which indicates a stack address, a control flag Flag which indicates an interrupt status, an interrupt enable or the like, and a program counter PC which stores an address of an instruction which is to be read next. The stack pointer SP indicates the address of a memory region which stores the register value, the interrupt return address and the like. The control signals supplied from the execute part 123 to the selectors 14 and 15 determine which one of the present register 160 and the previous register 161 is to be connected to the data bus 17 and the address bus 18.

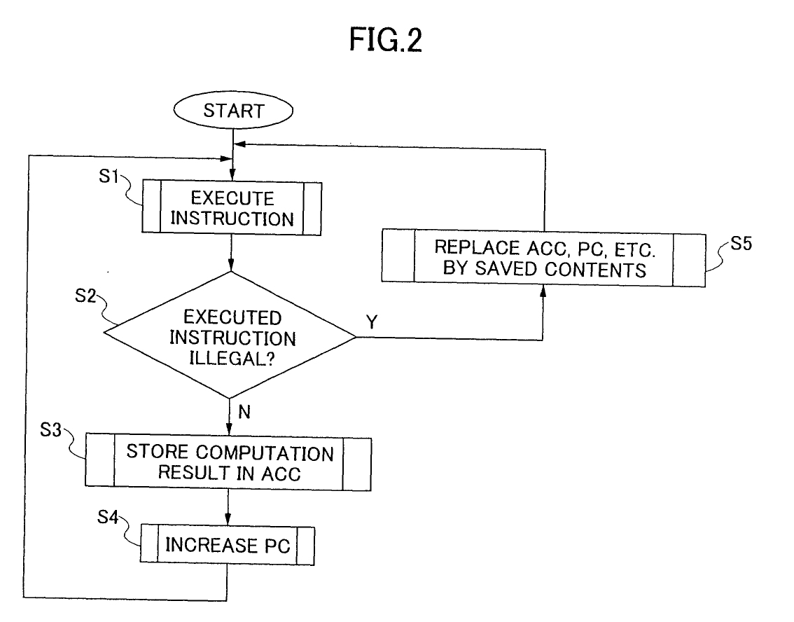

FIG. 2 is a flow chart for explaining the operation of this embodiment. In FIG. 2, a step S1 executes the instruction read by the read part 121 and decoded by the decode part 122, by the execute part 123. A step S2 decides whether or not the instruction decoded by the decode part 122 and executed by the execute part 123 is an illegal instruction. If the decision result in the step S2 is NO, a step S3 stores the computation result of the ALU 13 in the accumulator ACC of the present register 160, based on the instruction executed by the execute part 123. In addition, a step S4 increases the value of the program counter PC of the present register 160, and the process returns to the step S1.

On the other hand, if the instruction decoded by the decode part 122 and executed by the execute part 123 is an illegal instruction and the decision result in the step S2 is YES, a step S5 controls the selectors 14 and 15, so as to replace the contents of the accumulator ACC, the program counter PC and the like of the present register 160 by the contents of the accumulator ACC, the program counter PC and the like of the previous register 161, and the process returns to the step S1. Hence, if an illegal instruction is generated, the contents of the program counter PC, the accumulator ACC and the like of the present register 160 are replaced by the previous processing results stored in the previous register 161, so as to carry out again the process for which the illegal instruction was generated. Since a retry is carried out from the process at which the illegal instruction was generated, it is possible to minimize the interruption caused by the generation of the illegal instruction.

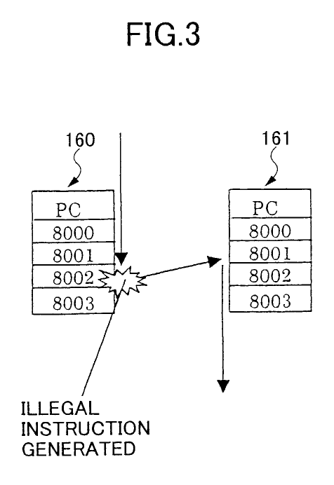

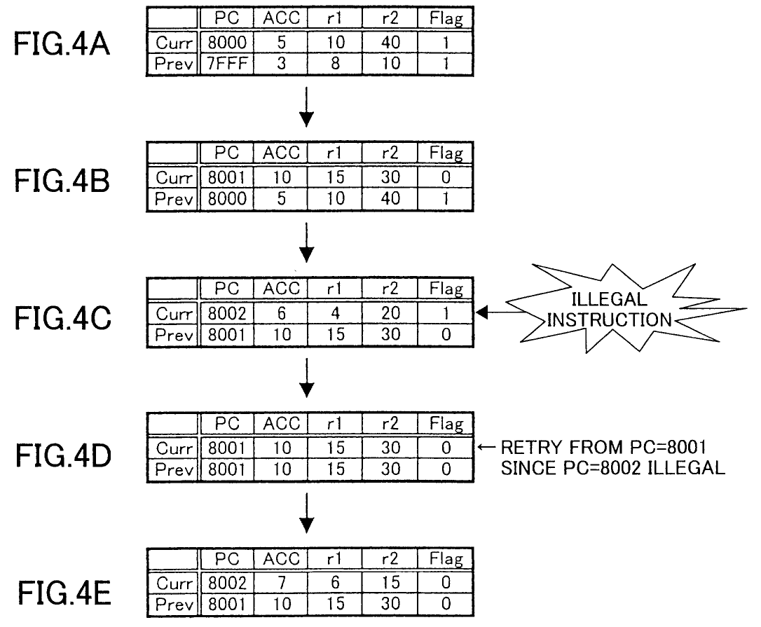

FIG. 3 is a diagram for explaining the operation of the first embodiment. In addition, FIGS. 4A through 4E are diagrams for explaining register contents of the first embodiment.

As shown in FIG. 3, if the illegal instruction is generated when the value of the program counter PC of the present register 160 is “8002”, this embodiment replaces the value of the program counter PC of the present register 160 by a value “8001”, so as to carry out the retry from the value “8001” of the program counter PC.

In other words, the process is carried out in a normal manner when the value of the program counter PC of the present register 160 is “8000” as shown in FIG. 4A and when the value of the program counter PC of the present register 160 is “8001” as shown in FIG. 4B. In FIGS. 4A through 4E, “Curr” indicates current (present), and “Prev” indicates previous. However, it is regarded that an illegal instruction is generated when the value of the program counter PC of the present register 160 is “8002” as shown in FIG. 4C. In this case, the value “8001” of the program counter PC of the previous register 161 shown in FIG. 4C replaces the value of the program counter PC of the present register 160, as shown in FIG. 4D. Similarly, the values of the accumulator ACC, the general purpose registers r1 and r2 and the control flag Flag of the present register 160 shown in FIG. 4C are replaced by the values of the accumulator ACC, the general purpose registers r1 and r2 and the control flag Flag of the previous register 161 shown in FIG. 4C, so that the register contents of the present register 160 become as shown in FIG. 4D. The retry is started from the value “8001” of the program counter PC of the present register 160 shown in FIG. 4D, and the register contents of the present register 160 become as shown in FIG. 4E if the retry is successful. The process is similarly continued thereafter.

Therefore, according to this embodiment, even when the illegal instruction is generated, the program is not interrupted immediately, and the retry is carried out several times, for example, so that the program may be executed continuously if the illegal instruction is eliminated as a result of the retry. The generation of the illegal instruction may be detected by an illegal instruction flag which is output from the decode part 122 within the pipeline processing section 12 of the processor 11. Accordingly, no program intervention is required from the error detection to the retry when the illegal instruction is generated, and the process continuity is maintained. In addition, compared to the case where two processors are used as in the first proposed method described above, the hardware structure and control are simple and the system can be realized inexpensively according to this embodiment.

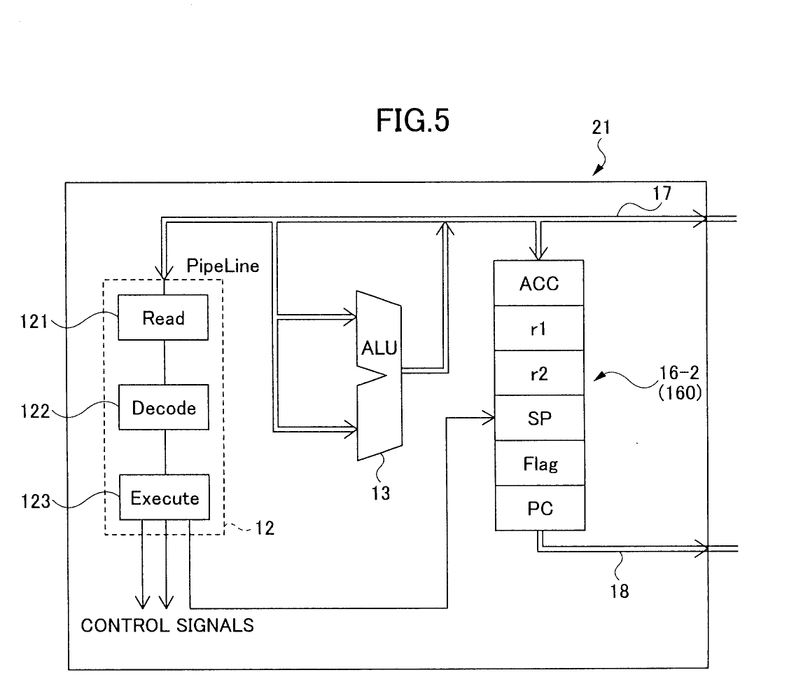

FIG. 5 is a system block diagram showing the general structure of a second embodiment of the processor according to the present invention. In this second embodiment of the processor, the present invention is applied to the CPU, and a second embodiment of the illegal instruction processing method is employed.

In FIG. 5, those parts which are the same as those corresponding parts in FIG. 1 are designated by the same reference numerals, and a description thereof will be omitted. In this embodiment, a register section 16-2 includes the present register 160 only.

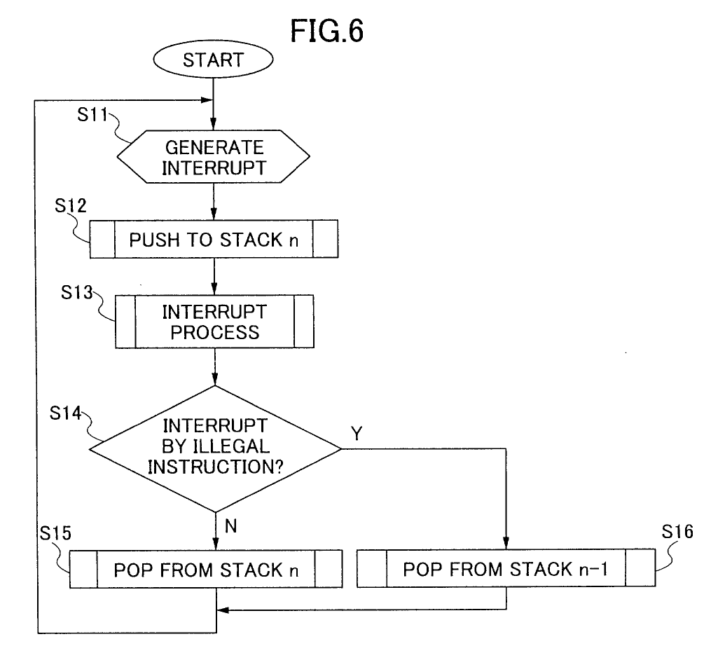

FIG. 6 is a flow chart for explaining the operation of this embodiment. In FIG. 6, a step S11 generates an interrupt when the decode part 122 of the pipeline process section 12 executes an illegal instruction. A step S12 pushes an internal register of a register section 16-2 to a stack n. A step S13 carries out an interrupt process, and a step S14 decides whether or not the interrupt is caused by the illegal instruction. If the decision result in the step S14 is NO, a step S15 pops from the stack n to the internal register, and the process returns to the step S11. On the other hand, if the decision result in the step S14 is YES, a step S16 pops from a stack n−1 to the internal register, and the process returns to the step S11.

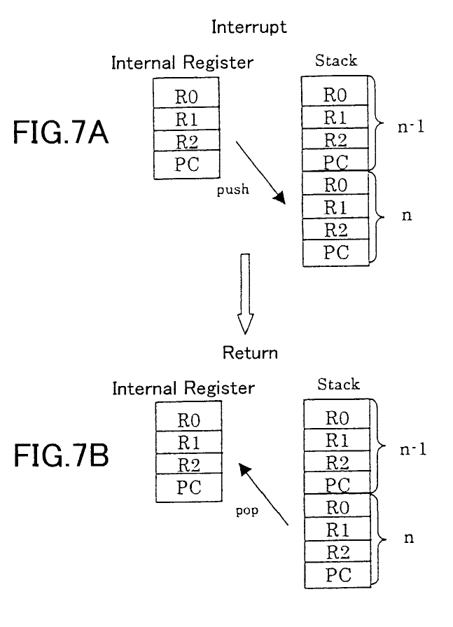

FIGS. 7A and 7B are diagrams for explaining register contents of a conventional processor, for comparison purposes. The internal register is pushes the stack n as shown in FIG. 7A, and in the case of the illegal instruction, the internal register is popped from the stack n as shown in FIG. 7B.

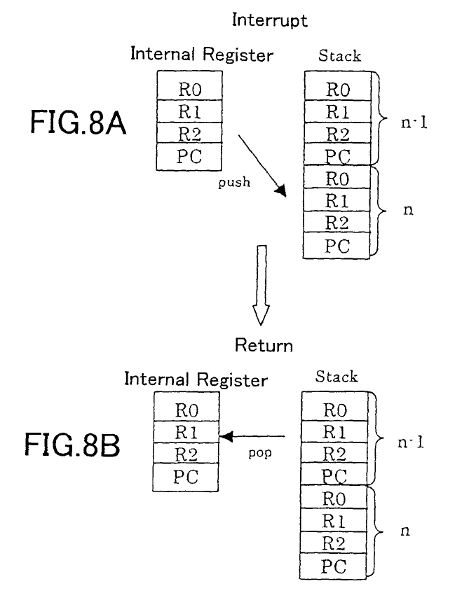

FIGS. 8A and 8B are diagrams for explaining register contents of the second embodiment. In this embodiment, the internal register pushes the stack n as shown in FIG. 8A, and the internal register is popped from the stack n−1 as shown in FIG. 8B.

Therefore, according to this embodiment, when returning from the interrupt caused by the illegal instruction, the return is made to an instruction prior to the instruction indicated by the stack pointer SP, so that a subroutine including the illegal instruction is re-executed after returning control to a state prior to the generation of the interrupt. In other words, the retry is executed from a subroutine immediately prior to the subroutine including the illegal instruction. The control flag Flag such as the interrupt status, the general purpose registers r1 and r2, the accumulator ACC and the like which were saved in the stack are used when re-executing the subroutine. In this case, the basic structure of the processor 21 may be the same as that of an existing processor, and only a function of changing a returning point upon generation of an illegal instruction needs to be added to the existing structure. For this reason, the hardware structure and control of this embodiment are simpler compared to those of the first embodiment described above, and this embodiment can realize an inexpensive system. Furthermore, compared to the third proposed method described above, this embodiment carries out the retry when the illegal instruction is generated, before the program is executed to the end, so that it is possible to effectively omit the execution time of the program which has no value when executed after the illegal instruction is generated.

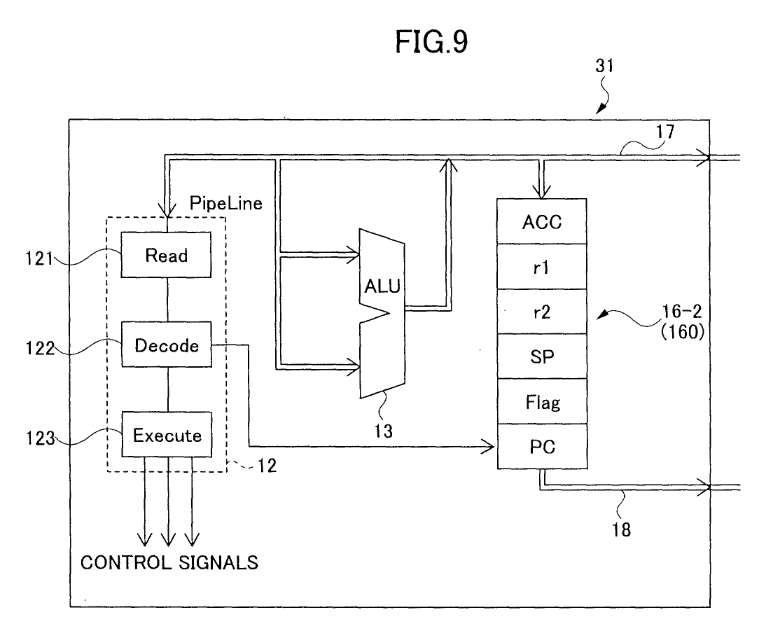

FIG. 9 is a system block diagram showing the general structure of a third embodiment of the processor according to the present invention. In this third embodiment of the processor, the present invention is applied to the CPU, and a third embodiment of the illegal instruction processing method is employed.

In FIG. 9, those parts which are the same as those corresponding parts in FIGS. 1 and 5 are designated by the same reference numerals, and a description thereof will be omitted. In this embodiment, a register section 16-2 includes the present register 160 only.

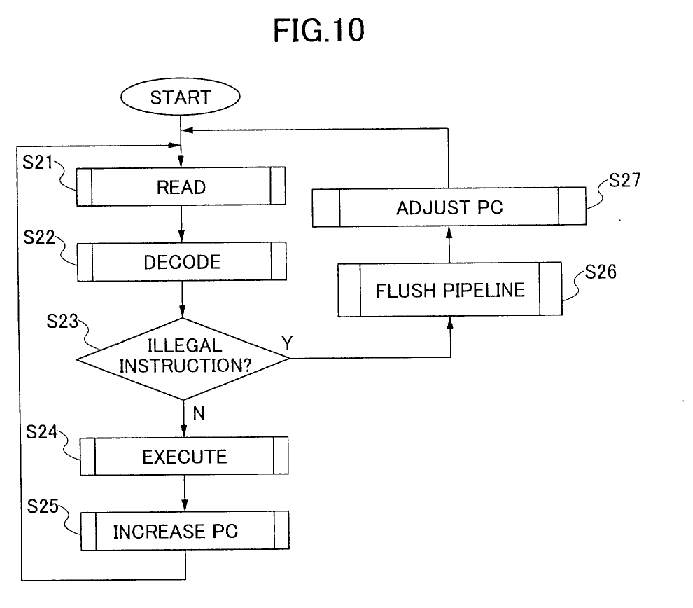

FIG. 10 is a flow chart for explaining the operation of this embodiment. In FIG. 10, a step S21 reads and stores an instruction by the read part 121 of the pipeline processing section 12. A step S22 decodes the instruction which is read by the read part 121, by the decode part 122 of the pipeline processing section 12. A step S23 decides whether or not the instruction decoded by the decode part 122 is supported, that is, whether or not the decoded instruction is an illegal instruction, by the decode part 122. If the decision result in the step S23 is NO, a step S24 executes the instruction which is decoded by the decode part 122, by the execute part 123 of the pipeline processing section 12, and supplies control signals to various parts within the processor 11. In addition, a step S25 increases the value of the program counter PC of the register section 16-2, and the process returns to the step S21.

On the other hand, if the illegal instruction is detected by the decode part 122 and the decision result in the step S23 is YES, a step S26 flushes the pipeline processing section 12 without executing the illegal instruction. In addition, a step S27 returns the value of the program counter PC of the register section 16-2 to a value which would enable the instruction which was regarded as an illegal instruction to be read again. In other words, the step S27 returns the value of the program counter PC by an amount corresponding to the number of stages forming the read part 121. The process returns to the step S21 after the step S27. Hence, the step S21 reads again the instruction which was regarded as an illegal instruction, and the process of the step S22 and the following steps are carried out similarly as described above.

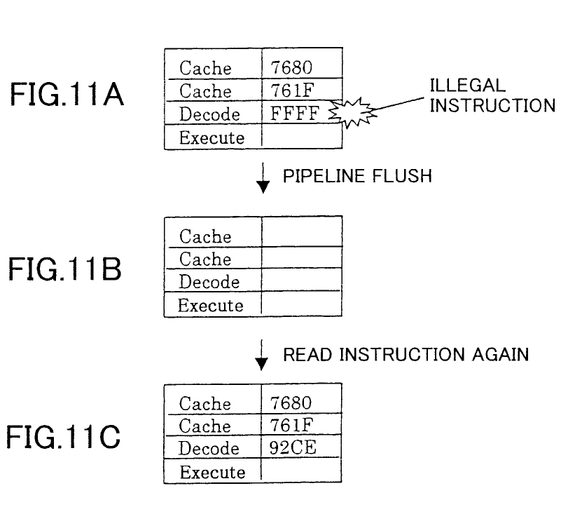

FIGS. 11A through 11C, FIG. 12 and FIG. 13 are diagrams for explaining particular operations of the third embodiment.

In FIGS. 11A through 11C, “Cache” indicates a code of an instruction which is read by the read part 121 of the pipeline processing section 12 and is stored in a cache memory within the read part 121, “Decode” indicates an instruction which is decoded by the decode part 122 of the pipeline processing section 12, and “Execute” indicates a result of executing the instruction by the execute part 123 of the pipeline processing section 12.

FIG. 11A shows a state where an illegal instruction “FFFF” is detected by the decode part 122 of the pipeline processing section 12, and corresponds to the case where the decision result in the step S23 shown in FIG. 10 is YES. FIG. 11B shows a state where the pipeline processing section 12 is flushed, and corresponds to the case where the step S26 shown in FIG. 10 is carried out. In addition, FIG. 11C shows a state where the instruction which was regarded as an illegal instruction is read again in the pipeline processing section 12, and corresponds to the case where the steps S27 and S21 shown in FIG. 10 are carried out after the step S26. Because the instruction is executed after the state shown in FIG. 11C, the result of executing the instruction is not yet indicated for “Execute” in FIG. 11C.

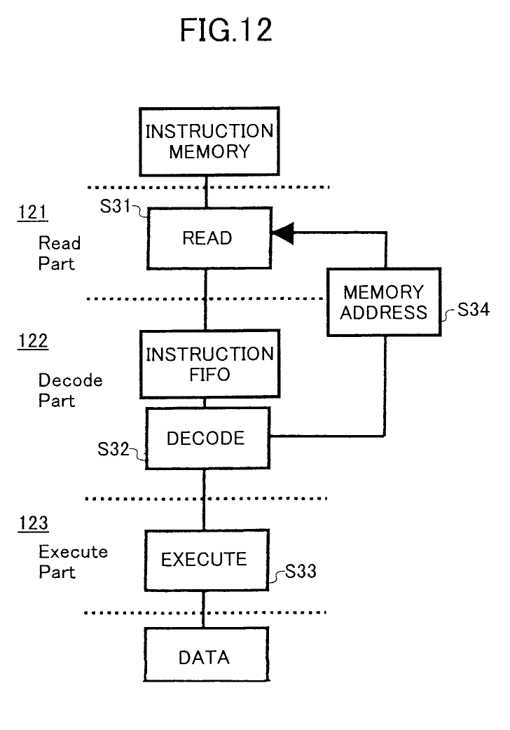

FIG. 12 shows a process flow within the pipeline processing section 12. In FIG. 12, the read part 121 reads an instruction from an instruction memory (not shown in FIG. 9) which may be formed by a flash ROM or the like, in a step S31. The decode part 122 stores the instruction read in the step S31 into an instruction FIFO or the like within the decode part 122, and decodes the stored instruction in a step S32. In a step S34, the register section 16-2 is accessed depending on the decoded instruction, so as to specify the address of the instruction to be read from the instruction memory. The execute part 123 executes the instruction which is decoded in the step S32, in a step S33, and outputs data obtained as a result of executing the instruction.

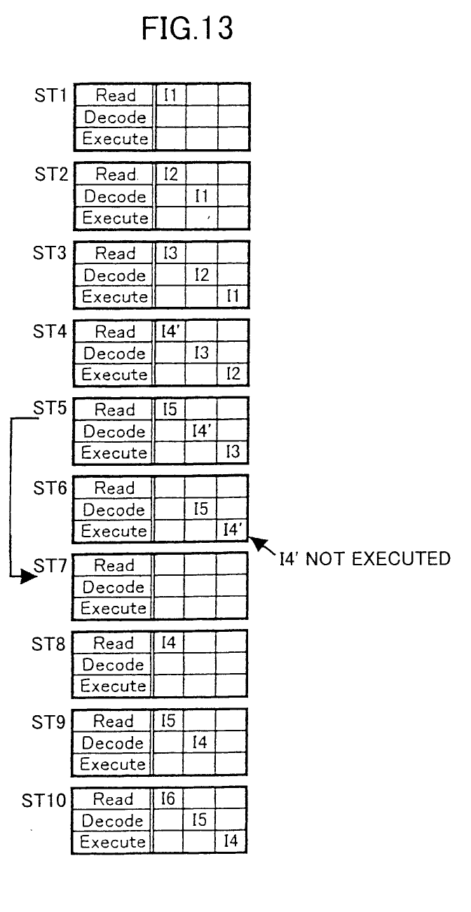

FIG. 13 shows instructions read by the read part 121 within the pipeline processing section 12, instructions decoded by the decode part 12 within the pipeline processing section 12, and instructions executed by the execute part 123 within the pipeline processing section 12. In FIG. 13, I1 through I6 denote instructions, and it is assumed that time progresses in a direction from the left column to the right column. For the sake of convenience, FIG. 13 shows the columns corresponding to three consecutive points in time.

Read, decode and execute of a normal pipeline process are carried out in states ST1 through ST4, however, it is assumed that the instruction I4 changes to an illegal instruction I4′ in the state ST4 for some reason and the illegal instruction T4′ is read, as shown in FIG. 13. For this reason, the illegal instruction I4′ is detected by the decode part 122 in a state ST5, and a transition is made from the state ST5 to a state ST7. In other words, the execute part 123 will not execute the illegal instruction I4′ as in a state ST6. In the state ST7, the read of the instruction from and subsequent to the state ST5 is stopped, and the instructions remaining in the pipeline processing section 12 is flushed without executing the illegal instruction I4′. In a state ST8, the instruction I4 is read again, and since the instruction I4 is read normally in this case, the read, decode and execute of the normal pipeline process are carried out in states ST9 and ST10.

In the first embodiment described above, the retry is started from an immediately preceding step without program intervention when the execution of an illegal instruction is detected. In the second embodiment described above, the retry is started from an immediately preceding subroutine without program intervention when the execution of an illegal instruction is detected. But in this third embodiment, when the reading of an illegal instruction is detected, the read illegal instruction is not executed and the instruction is read again without program intervention.

Further, the present invention is not limited to these embodiments, but various variations and modifications may be made without departing from the scope of the present invention.

What is claimed is:

1. An illegal instruction processing method adapted for a processor which executes programs, comprising:
detecting execution of an illegal instruction; and
carrying out a retry from an instruction immediately prior to the illegal instruction when the execution of the illegal instruction is detected.

2. The illegal instruction processing method as claimed in claim 1, wherein said retry is carried out after replacing present register contents at least including an accumulator, a stack pointer and a program counter by previous register contents when the execution of the illegal instruction is detected.

3. An illegal instruction processing method adapted for a processor which executes programs, comprising:
detecting execution of an illegal instruction; and
carrying out a retry from a subroutine immediately prior to a subroutine including the illegal instruction when the execution of the illegal instruction is detected.

4. The illegal instruction processing method as claimed in claim 3, wherein said retry re-executes the subroutine including the illegal instruction after returning control to a state prior to when an interrupt is generated by the illegal instruction, by returning to a point preceding an instruction indicated by a stack pointer when returning from the interrupt, when the execution of the illegal instruction is detected.

5. An illegal instruction processing method adapted for a processor which executes programs, comprising:
detecting reading of an illegal instruction; and
reading an instruction again without executing the illegal instruction when the reading of the illegal instruction is detected.

6. The illegal instruction processing method as claimed in claim 5, wherein the reading of the illegal instruction is detected by decoding a read instruction.

7. The illegal instruction processing method as claimed in claim 5, wherein said reading again of the instruction includes adjusting a program counter by flushing a pipeline processing section when the reading of the illegal instruction is detected, and reading again the instruction which is detected as the illegal instruction based on a value of the adjusted program counter.

8. A processor for executing programs, comprising:
a detecting part detecting execution of an illegal instruction; and
a retry part carrying out a retry from an instruction immediately prior to the illegal instruction when the execution of the illegal instruction is detected by the detecting part.

9. The processor as claimed in claim 8, further comprising:
a register section storing present and previous register contents at least including an accumulator, a stack pointer and a program counter,
said retry part carrying out the retry after replacing the present register contents by the previous register contents when the execution of the illegal instruction is detected by the detecting part.

10. A processor for executing programs, comprising:
a detecting part detecting execution of an illegal instruction; and
a retry part carrying out a retry from a subroutine immediately prior to a subroutine including the illegal instruction when the execution of the illegal instruction is detected by the detecting part.

11. The processor as claimed in claim 10, wherein said retry part re-executes the subroutine including the illegal instruction after returning control to a state prior to when an interrupt is generated by the illegal instruction, by returning to a point preceding an instruction indicated by a stack pointer when returning from the interrupt, when the execution of the illegal instruction is detected by the detecting part.

12. A processor for executing programs, comprising:
a detecting part detecting reading of an illegal instruction; and
a reading section reading an instruction again without executing the illegal instruction when the reading of the illegal instruction is detected by the detecting part.

13. The processor as claimed in claim 12, wherein said reading section detects the reading of the illegal instruction by decoding a read instruction.

14. The processor as claimed in claim 12, further comprising:
a pipeline processing section including a read part, a decode part and an execute part,
wherein said reading section is formed by said read part and said decode part, and
said reading section includes means for adjusting a program counter by flushing the pipeline processing section when the reading of the illegal instruction is detected by the detecting part, and means for reading again the instruction which is detected as the illegal instruction based on a value of the adjusted program counter.
